(19) United States
(12) Patent Application Publication
(10) Pub. No.: US 2017/0267597 A1
(43) Pub. Date: Sep. 21, 2017

(54) METHOD FOR PRODUCING FERTILIZER FROM A BIOPOLYMER, AND FERTILIZER

(71) Applicant: S2P AG Straw - Pulp and Paper, Alpnach Dorf (CH)

(72) Inventor: Karl-Heinz HORNLEIN, Schindellegi (CH)

(73) Assignee: S2P AG Straw - Pulp & Paper, Alpnach Dorf (CH)

(21) Appl. No.: 15/532,022

(22) PCT Filed: Sep. 22, 2015
(86) PCT No.: PCT/EP2015/071695

§ 371 Date: May 31, 2017

(30) Foreign Application Priority Data
Dec. 1, 2014 (EP) 14195619.3

(51) Int. Cl. C05C 11/00; C05G 3/00

(52) U.S. Cl. CPC C05C 11/00; C05G 3/0058

(57) ABSTRACT

The invention relates to a method for producing a nitrogen-containing fertilizer from a liquid black liquor, wherein a black liquor is formed from lignocellulose-containing biomass. A majority of contained lignin constituents are decomposed into monomeric, dimeric to trimeric compounds, and at least one free alkanolamine, in particular monoethanolamine, is removed from the liquid black liquor. The black liquor is cooled to room temperature and combined with water, a defined flowable state of the black liquor being set. The flowable black liquor is supplied to a mixing device and combined with powder solids so as to form a pasty mixture which is formed into granules.

The invention relates to a method for producing a nitrogenous fertilizer from liquid black liquor according to claim 1 and to a fertilizer according to claim 12.

As a biopolymer source black liquor can be used in accordance with the invention. Black liquor is a process product rich in energy and lignin which is produced in large quantities as a waste product e.g. in the cellulose production in the paper industry. This arises in the separation of lignin from cellulose. The disposal of large quantities of black liquor proves to be burdensome and costly. Various efforts have already been undertaken to utilize black liquor in a reasonable and efficient way. It is generally known that black liquor is nitrogenous which is of particular interest for the production of fertilizer. Due to contamination with caustic and aggressive constituents the black liquor is normally fed away into incineration for energy recovery.

The invention is based on the object to provide an efficient method for producing a nitrogenous fertilizer from liquid black liquor and a fertilizer which meets high quality standards.

According to the invention the object is achieved on the one hand by a method having the features of claim 1 and on the other hand by a fertilizer having the features of claim 12. Preferred embodiments are stated in the respective dependent claims.

The method according to the invention is characterized in that from the liquid black liquor at least one noxious substance is removed, the black liquor is cooled to room temperature and mixed with water, wherein a defined flowable state of the black liquor is set, the flowable black liquor is supplied to a mixing device and mixed with powdery solids into a pasty mixture, and the mixture is shaped into granules.

A basic idea of the invention resides in the fact that for the production of a nitrogenous fertilizer black liquor is decontaminated and made available as solid material. According to one aspect of the invention the decontamination of the black liquor is achieved in that free unbonded chemicals e.g. stemming from the production process of the black liquor, in particular monoethanolamine, are separated. In this way, a black liquor can be obtained which has been extracted from chemicals that are of concern for human health and the environment. Such a black liquor is largely free at least of alkanolamines, and preferably of monoethanolamine.

According to the invention noxious substances are to be understood as substances which, according to general specialized knowledge, pose a danger to human health and the environment. The term “noxious substance” refers, in particular, to the toxicity, the irritation potential and/or the caustic effect of a substance.

In order that the black liquor obtained is rendered economically manageable and usable provision is made according to a further aspect of the invention in that through the addition of powdery solids, solvents and/or auxiliary agents the black liquor is mixed by means of a mixing means into a pasty mixture, whereby the shaping of granules is rendered possible.

According to the invention the liquid black liquor is to be understood as a lignin-containing mixture of various substances or chemicals. The black liquor can be obtained from lignocellulose-containing biomass, from which the lignin proportion, together with other substances, is separated from the poorly soluble cellulose and hemicellulose constituents of the plant raw materials. The liquid black liquor can therefore also comprise substances from the production process of the black liquor as well as further substances from the plant constituents. The contained substances are not confined to the substances supplied during the production process but also include those substances which only arise through the production process of the black liquor.

For the method according to the invention use is preferably made of black liquor that arises in an alkanolamine process for the production of cellulose. According to a finding of the invention this black liquor has a particularly high nitrogen content and is less contaminated.

The liquid black liquor can also comprise those substances that can have an effect on the viscosity of the liquid black liquor. In particular, this concerns at least one free alkanolamine, preferably free monoethanolamine.

The powdery solids can prove beneficial to the method according to the invention in several respects. On the one hand, due to their properties the powdery solids can bind liquid proportions in an especially useful manner in the treated black liquor and thereby influence the pastosity of treated black liquor. On the other hand, they can serve to supplement the treated black liquor with substances which impart advantageous properties, especially fertilizer properties, to the product.

A preferred further development of the invention can reside in the fact that as noxious substance an alkanolamine, more particularly an alkanolamine having one to four carbon atoms, preferably monoethanolamine, monopropanolamine, mono-butanolamine and/or diglycolamine is removed. Alkanolamines with both branched and unbranched carbon chains can be used. According to a further development of the invention it is especially preferred that monoethanolamine is used as alkanolamine. Especially alkanolamines with a short carbon chain length show advantageous properties during the formation of the black liquor from lignocellulose-containing biomass. After formation of the black liquor these short-chain alkanolamines can be separated therefrom again in a particularly easy way.

An advantageous embodiment of the invention resides in the fact that free alkanolamine, preferably monoethanolamine, is removed from the black liquor through distillation, thin-film evaporation, (falling-) film evaporation, spray drying, tube evaporation, precipitation with subsequent filtration, centrifugation or pressing. Especially short-chain free alkanolamines can be separated particularly easily from the black liquor through distillation or another evaporation method. In this, the comparatively low boiling point of short-chain free alkanolamines can be of advantage. A separation of free alkanolamine can also be accomplished in that a non-solvent is added to the liquid black liquor with free alkanolamine. In doing so, the black liquor, more particularly the lignin proportion, can precipitate in the form of solid particles and can be separated from free alkanolamine through an appropriate solid/liquid separation process, such as filtration, centrifugation or pressing. Likewise, a separation of free alkanolamine can be attained in that a precipitation of the liquid black liquor, more particularly of the lignin proportion, is brought about through the introduction of carbon dioxide, preferably in the presence of water. In this case, the black liquor is obtained in the form of solid particles. This residue consists in a degraded, reactive black liquor.

An expedient further development of the invention is achieved in that the black liquor is nitrogenous, in particular being formed with a proportion of at least one bonded alkanolamine, preferably monoethanolamine. A nitrogen content of the black liquor can be attained, for example, in that bonded nitrogenous compounds, especially alkanolamines, are present in the black liquor. In particular, these can be bonded to a lignin proportion. Bonded nitrogenous compounds, especially bonded alkanolamine, do not have the same caustic or environmentally harmful as well as toxic properties as the same compounds in free, unbonded form. By forming the black liquor with a nitrogen proportion bonded to the black liquor, in particular with a proportion of at least one nitrogenous substance, a delayed release of the nitrogenous compounds in the course of microbial disintegration or weathering of the black liquor is ensured. Therefore, such a black liquor that has e.g. bonded alkanolamine, in particular monoethanolamine, can be used as a depot fertilizer, allowing microorganisms to convert the black liquor into nitrogen compounds available to plants.

A particularly preferred further development of the invention provides that the powdery solids comprise organic and/or inorganic fertilizer components, in particular nitrogenous, phosphoric and/or potassic substances, minerals, binding agents, bentonite, leonardite, trace elements, other plant nutrients, plant protection agents, soil conditioners, microorganisms or a combination thereof. The addition of organic and/or inorganic fertilizer components as powdery solids to the black liquor according to the invention can have a favorable effect on plant growth. In this connection, the fertilizer components are to be understood, in particular, as those substances that are structurally needed by the respective plant for the generation of biomass, substances that accelerate and/or promote plant growth as well as substances that stimulate plant growth in so far as they protect plants against external influences that may have a detrimental, retardant or decelerating effect on plant health or growth. In particular, those substances can comprise fungicides, herbicides, pesticides as well as any other substance or composition familiar to the skilled person for the protection of plants against external influences. External influences also comprise those influences that may take effect not only on the surface but also inside the plant, such as diseases, parasites or plant toxins. Furthermore, according to the invention substances or compositions are to be understood as fertilizer components which change the soil in a manner favorable to plant growth. The term “organic and/or inorganic fertilizer components” is to be understood in the manner familiar to the skilled person. Moreover, the term “organic fertilizer components” also comprises biological fertilizer components, such as organic fertilizers as well as microorganisms. Such microorganisms can control degradation and disintegration processes of the fertilizer components and thereby provide for a need-oriented release of nutrients.

A particularly expedient further development of the invention can be accomplished in that the black liquor and the solids are supplied to an extruder and mixed therein and at the exit of the extruder are extruded into strands which are cut into the granules. Through extrusion a specific plastic moldability and flowability of the granular mass can be achieved and a granular material of particular dimensional stability can be produced once the extruded strands have been cut. For cutting provision is preferably made for a cutting means, in particular a rotating knife, on the outside of the plate-shaped shaping tool. In this case, by way of the extruder the mixing device according to the invention is realized at the same time. Through pressure and the supply of liquid the desired, preferably pasty consistency of the mixture can be set. In particular, use can be made of a multi-screw extruder in co-rotating or counter-rotating operation. This ensures a good mixing and pre-treatment of the extrusion mass. The use of an extruder renders it possible that the grain sizes of the shaped granules lie in the same or at least in a similar range. Alternatively, an advantageous embodiment of the invention can reside in the fact that the granules are produced through agglomeration. By means of capillary forces, binding agents, molecular attraction as well as interlocking bonds along with a rugged or fibrous surface an enlargement of the grain size can be achieved through movement of the material to be agglomerated.

A preferred further development of the invention can reside in the fact that the black liquor is formed of lignocellulose-containing biomass, in particular of annual plants, preferably of cereal straw, and has at least partially low-molecular lignin. Lignin is a major constituent of the black liquor formed of lignocellulose. In the decomposition of this biomass the biopolymer-lignin can be broken down into smaller lignin constituents or low-molecular lignin units. In this connection, one can also speak of a degraded or reactive lignin. Lignocellulose is contained both in wood-containing and wood-free plants. According to a further development of the invention it is particularly preferred that black liquor is formed of wheat straw. However, use can also be made of any other plant material with a proportion of lignocellulose.

An especially advantageous embodiment of the invention resides in the fact that during the formation of the black liquor contained lignin constituents are broken down to a major part into monomeric, dimeric to trimeric compounds. A high proportion of formed monomeric, dimeric to trimeric compounds of the lignin units of the black liquor can have a favorable influence on the proportion of bonded alkanolamine, in particular monoethanolamine in the black liquor. Particularly preferred is a proportion of monomeric, dimeric to trimeric compounds of the lignin constituents ranging from 20% to 90%, preferably from 40% to 60% of the lignin on hand.

A particularly advantageous further development of the invention resides in the fact that in order to form the black liquor the lignocellulose-containing biomass is decomposed by way of at least one alkanolamine, in particular by way of monoethanolamine. Alkanolamine, especially monoethanolamine, can contribute to the formation of black liquor from lignocellulose-containing biomass, in particular during the separation of the cellulose and hemicellulose proportions from the lignin constituents and further soluble black liquor constituents. The poorly soluble residue can be supplied to further processing for the recovery of cellulose. To allow for an increased yield of black liquor from the lignocellulose-containing biomass it may be of advantage that a further solvent for lignin constituents is additionally used. By preference, the further solvent can have a proportion of water. During the extraction of the black liquor from the lignocellulose-containing biomass it may be of advantage that the reaction temperature lies above room temperature but below the disintegration temperature of employed alkanolamine. An increased reaction temperature during the recovery of the black liquor can contribute to a quicker and more comprehensive dissolution of the lignin constituents from the lignocellulose-containing biomass.

A preferred further development of the invention can reside in the fact that further auxiliary agents are supplied to the decomposition of the lignocellulose-containing biomass to improve the yield, reaction time and/or to reduce the required reaction temperature. The presence of auxiliary agents, in particular of catalytic auxiliary agents, can influence the decomposition of the lignocellulose-containing biomass to its advantage. Decomposition reactions on the biomass are fostered in the presence of the auxiliary agents while side reactions are greatly reduced. The catalytic auxiliary agents preferably comprise catalytic quinones, especially in the form of naphthoquinone, anthraquinone, anthrone, phenanthrenequinone. Anthraquinone has proved to be particularly advantageous as catalytic auxiliary agent but also alkyl-substituted derivatives thereof, such as 2-methyl-anthraquinone, 2-ethyl-anthraquinone, 2,6-dimethyl-anthraquinone, 2,7-dimethyl-anthraquinone and the like, can be beneficial for the decomposition of the lignocellulose-containing biomass.

According to a further development of the invention it is especially advantageous that during the formation of the black liquor biopolymers, in particular cellulose, are produced and separated from the black liquor. These are biopolymers of low solubility which are preferably used in the paper production.

According to a further development of the invention it is particularly preferred that in order to purify the black liquor biopolymers of low solubility are separated through filtration, centrifugation, sedimentation, pressing or washing. Depending on the design of the respective separation process between black liquor and poorly soluble lignocellulose constituents it may be necessary to carry out further steps to purify the black liquor from poorly soluble constituents, in particular cellulose and hemicellulose constituents. In this, the comparatively high solubility of black liquor in suitable solvents can be used advantageously in the separation of poorly soluble constituents.

A particularly preferred embodiment of the invention resides in the fact that the fertilizer comprises granules that are formed of a mixture of black liquor and powdery solids. In this connection, it is particularly preferred that the black liquor is nitrogenous. After the shaping of the granules the extruded pasty mixture comprising black liquor and powdery solids can be freed of existing solvents by a suitable method familiar to the skilled person in order to produce dimensionally stable fertilizer granules. This can be implemented, in particular, through heat, low pressure, a binder for solvents or a combination thereof. Due to the fact that the black liquor in the granules contains, in particular, bonded alkanolamine, preferably monoethanolamine, the drying process of the extruded pasty mixture does not lead to a significant loss of nitrogenous constituents of the granules which can be supplied for use as fertilizer.

According to a further development of the invention it is especially preferred that the granules contain bonded alkanolamine, preferably monoethanolamine, preferably with a proportion of 1% to 40% of bonded alkanolamine, in particular monoethanolamine. In order that an adequate supply of a nitrogenous compound available to plants is ensured by the granules according to the invention it is of advantage that a high proportion of bonded alkanolamine, in particular monoethanolamine, is made available in the processed black liquor. Depending on the design of the production process of the black liquor the proportion of bonded alkanolamine can be subject to variations. In this, the absorption of alkanolamine by the black liquor into bonded alkanolamine, more particularly bonded monoethanolamine, can depend on the proportion of low-molecular compounds formed, in particular the monomeric, dimeric to trimeric compounds of the lignin units in the black liquor.

In particular, provision is made in accordance with the invention in that a method for producing a nitrogenous fertilizer is provided, in which a black liquor is formed of lignocellulose-containing biomass, wherein contained lignin constituents are broken down to a major part into monomeric, dimeric to trimeric compounds, from the liquid black liquor at least free alkanolamine is removed as a noxious substance, wherein bonded alkanolamine remains in the black liquor, the black liquor with the bonded alkanolamine is cooled to room temperature and mixed with water, wherein a defined flowable state of the black liquor is set, the flowable black liquor is supplied to a mixing device and mixed with powdery solids, which comprise organic and/or inorganic fertilizer components, into a pasty fertilizer mixture and the pasty fertilizer mixture is shaped into fertilizer granules.

1. Method for producing a nitrogenous fertilizer, in which
a black liquor is formed of lignocellulose-containing biomass, wherein contained lignin constituents are broken down to a major part into monomeric, dimeric to trimeric compounds,
from the liquid black liquor at least free alkanolamine is removed as a noxious substance, wherein bonded alkanolamine remains in the black liquor,
the black liquor with the bonded alkanolamine is cooled to room temperature and mixed with water, wherein a defined flowable state of the black liquor is set,
the flowable black liquor is supplied to a mixing device and mixed with powdery solids, which comprise organic and/or inorganic fertilizer components, into a pasty fertilizer mixture and
the pasty fertilizer mixture is shaped into fertilizer granules.

2. Method according to claim 1,
wherein
as noxious substance alkanolamine having 1 to 4 carbon atoms, preferably monoethanolamine, monopropanolamine, monobutanolamine and/or diglycolamine, is removed.

3. Method according to claim 1,
wherein
free alkanolamine, preferably monoethanolamine, is removed from the black liquor through distillation, thin-film evaporation, (falling-) film evaporation, spray drying, tube evaporation, precipitation with subsequent filtration, centrifugation or pressing.

4. Method according to claim 1,
wherein
the black liquor is formed with a proportion of monoethanolamine as a bonded alkanolamine.

5. Method according to claim 1,
wherein
the powdery solids comprise nitrogenous, phosphoric and/or potassic substances, minerals, binding agents, bentonite, leonardite, trace elements, other plant nutrients, plant protection agents, soil conditioners, microorganisms or a combination thereof.

6. Method according to claim 1,
wherein
the black liquor and the solids are supplied to an extruder and mixed therein and at the exit of the extruder are extruded into strands which are cut into the granules.

7. Method according to claim 1,
wherein
the black liquor is formed of annual plants as lignocellulose-containing biomass, preferably of cereal straw, and has at least partially low-molecular lignin.

8. Method according to claim 1,
wherein
to form the black liquor the lignocellulose-containing biomass is decomposed by way of at least one alkanolamine, in particular by way of monoethanolamine.

9. Method according to claim 7,
wherein
further auxiliary agents are supplied to the decomposition of the lignocellulose-containing biomass to improve the yield, reaction time and/or to reduce the required reaction temperature.

10. Method according to claim 7,
wherein
during the formation of the black liquor biopolymers, in particular cellulose, are produced and separated from the black liquor.

11. Method according to claim 7,
wherein
to purify the black liquor biopolymers of low solubility are separated through filtration, centrifugation, sedimentation, pressing or washing.

12. Fertilizer produced according to a method according to claim 1,
wherein
the fertilizer comprises granules which are formed of a mixture of black liquor and powdery solids.

13. Fertilizer according to claim 12,
wherein
the black liquor is nitrogenous.

14. Fertilizer according to claim 12,
wherein
the granules contain bonded alkanolamine, preferably monoethanolamine, preferably with a proportion of 1% to 40% of bonded alkanolamine, in particular monoethanolamine.
